(19) United States
(12) Patent Application Publication
(10) Pub. No.: US 2017/0167457 A1
(43) Pub. Date: Jun. 15, 2017

(54) PRELOADED SPRING FOR USE WITH A PIEZOELECTRIC FUEL INJECTOR

(71) Applicant: ECOMOTORS, INC., Allen Park, MI (US)

(72) Inventor: Scott GRAVES, Mountain View, CA (US)

(73) Assignee: EcoMotors, Inc., Allen Park, MI (US)

(21) Appl. No.: 15/116,397

(22) PCT Filed: Feb. 6, 2015
(86) PCT No.: PCT/IB2015/050909

§ 371 Date: Aug. 3, 2016

Related U.S. Application Data
(60) Provisional application No. 61/937,270, filed on Feb. 7, 2014.

(51) Int. Cl. F02M 51/06; F02M 61/16

(52) U.S. Cl. CPC F02M 51/0603; F02M 51/06; F02M 61/16

(57) ABSTRACT

A: piezoelectric fuel injector spring assembly and an assembly method for assembling such a piezoelectric fuel injector spring assembly. The assembly has a piezoelectric element (204}, a first spring {212), and a second spring (210). The first spring (212) biases the second spring (210) by expanding the second spring {210}, and the second spring {210} is further expanded when the piezoelectric element (204) expands. For the assembly, the first spring is compressed by an external compressing force prior to connecting a second end of the second spring to a second end of the piezoelectric element, and after connecting the external force is released allowing establishment of spring force equilibrium between the first and second spring.

### BACKGROUND OF THE INVENTION

Field of the Invention

The present invention relates generally to fuel injectors utilizing piezoelectric elements and more particularly to piezoelectric fuel injectors further utilizing springs.

Description of the Related Art

Most modern internal combustion engines utilize a fuel injection system to deliver atomized fuel to the engine by forcibly pumping the fuel through a small nozzle under high pressure. These fuel injection systems, tend to be more precise and efficient than previously used carburetors. Typical fuel injectors utilized in these systems often utilize hydraulically, electromagnetically, or piezoelectrically actuated injector pins.

A piezoelectric element is a material that changes dimensions when a voltage is applied across the element. When the voltage is removed, the piezoelectric element returns to its original dimensions. When used as actuators, many piezoelectric elements are stacked together to form, larger piezoelectric elements or “piezoelectric stacks” to increase the displacement of the actuator. In a piezoelectrically actuated fuel injector, one or more of these piezoelectric elements or piezoelectric stacks are used to actuate a fuel injector pin for fuel metering into an internal combustion engine. Various spring-like structures are often used in conjunction with these devices to apply a return force and thus facilitate the return of the fuel injector pin to its “resting” position after the piezoelectric stack is no longer actuated.

One problem that occurs when utilizing a piezoelectric stack in a fuel injector, is that effective functioning of the piezoelectric stack requires a sufficient preload force to be established during assembly of the relevant portion of the injector containing the stack. The required preload force to apply the return force for workable packaging requirements is: usually higher than can be provided by a standard coil spring and is therefore insufficient. Accordingly, typical fuel injectors utilizing piezoelectric stacks tend to utilize a tube spring to provide the return force. A tube spring is essentially a cylindrical tube having a pattern of slots and/or grooves to provide increased axially flexible. An example arrangement of the use of tube spring structures can be found in European patent BP 1 548 854 A1, to Siemens VDO Automotive.

One problem with utilizing a tube spring to provide the return force, is that tube springs tend to be fairly stiff (i.e. they have a high spring rate) and therefore require using a significantly precise assembly process to provide a preload force within an acceptable range of tolerances.

Other options currently utilized in attempt to provide springs that can support an adequate preload force include utilizing threaded collar structures, however, such structures complicate the fuel injection process by adding unwanted torque to the piezoelectric stack. Other complicated apparatuses can also be designed to hold the above mentioned tubular springs to promote a specific and more accurate stretch, however, these apparatuses can be high cost, can have delicate production requirements and can add additional complicated components to the fuel injector.

Press-fit sleeves which still retain slight movement are also sometimes used for the above purposes, however these structures share the undesirable complications of the above mentioned apparatuses. Finally, Belleville springs are sometimes utilized, however, this can result in undesirable packaging arrangements and high stress being applied to the Belleville springs, which can damage them and thus reduce the useful life of the fuel injector.

An efficient method and device to accommodate for a sufficient preload force for a piezoelectric stack utilized within a fuel injector is therefore needed.

### SUMMARY OF THE INVENTION

Described herein are methods and devices for efficiently accommodating for a sufficient preload force for a piezoelectric stack utilized within a fuel injector. Methods incorporating features of the present invention can include accommodating for a sufficient preload force, for example, during assembly of a fuel injector section, by arranging a piezoelectric element within an injector body with a plurality of springs comprising at least two different types of springs arranged in conjunction with one another. A preload force can fee applied to the piezoelectric element, compressing a first type of spring while allowing a second type of spring to remain at its free length. The piezoelectric element can then toe further enclosed within the body portion and/or the second type of spring affixed in place, allowing the springs to provide the necessary preload force. This and other methods are set forth in more detail further below.

Devices incorporating features of the present invention can comprise a piezoelectric element and a plurality of springs which can be at least two different types of springs that are arranged in conjunction with one another to provide a sufficient preload force to the piezoelectric element. In some embodiments, the plurality of springs comprises one or more tube springs configured in series with one or more Belleville springs.

These and other further features and advantages of the invention would be apparent to those skilled in the art based on the following detailed description, taking together with the accompanying drawings, in which:

### BRIEF DESCRIPTION OF THE DRAWINGS

FIG. 1 is a cut away view of a fuel injector, demonstrating an example environment in which devices and methods according to the present invention can toe applied;

FIG. 2 is a sectional view of a free, unloaded piezoelectric element configuration incorporating features of the present invention;

FIG. 3 is a sectional view of the piezoelectric element configuration of FIG. 2 showing a preload force being applied and the piezoelectric element being compressed;

FIG. 4 is a sectional view of the piezoelectric element configuration of FIG. 2 showing a preloaded piezoelectric assembly; and

FIG. 5 is a perspective view of the preloaded piezoelectric assembly of FIG. 4.

### DETAILED DESCRIPTION OF THE INVENTION

Piezoelectric element packages for use in a fuel injector that incorporate features of the present invention can comprise a piezoelectric element and a plurality of springs comprising at least two different types of springs that are arranged in conjunction with one another to provide a sufficient preload force to the piezoelectric element. In some embodiments, the

plurality of springs comprises one or more tube springs configured in series with one or more Belleville springs.

The piezoelectric element can be a single piezoelectric element or can be multiple piezoelectric elements arranged in conjunction with one another to form one or more piezoelectric stacks, The shape of the piezoelectric element can vary based on delivery of an electric current. The piezoelectric element can be configured in communication with the injector pin so that movement of the piezoelectric element in response to activation is transferred to the pin to be moved in a desired direction in response to actuation of the piezoelectric element. When the electric current is no longer applied to the piezoelectric element, the piezoelectric element and the pin return to a “resting” position. Various structures such as the use of one or more springs can be utilized in conjunction with the piezoelectric element to apply a return force and facilitate the return of the piezoelectric element to the “resting” position.

A plurality of springs can comprise various configurations and arrangements of springs within the plurality and can comprise at least two different types of springs. These different types of springs can be configured in conjunction with one another such that the package can be arranged with an acceptable preload force and the springs within the plurality can accommodate this preload force within the spring life cycle or the integrity of the package.

In some embodiments, the plurality of springs comprises one or more tube springs and one or more Belleville springs. In some embodiments, the tube springs and the Belleville springs are arranged in series with one another. One advantage of arranging the tube and Belleville springs in series with one another is that the springs can provide an adequate return force without the preload force applying a significant amount of stress on the springs. By arranging the tube springs and Belleville springs in series, much of the individual drawbacks of the spring types, are alleviated, for example, the high spring rate of the tube springs is mitigated by the Belleville spring components of the plurality and the stress applied to the Belleville springs is mitigated by the tube spring components. In other embodiments, the tube springs and Belleville springs can be arranged in parallel with one another. However, the parallel arrangement could increase the stiffness and thus reduce the aforementioned benefit.

In assembling the tube spring/Belleville spring embodiments of a piezoelectric injector package, the piezoelectric element is arranged in conjunction, with the tube spring and Belleville springs such that a preload compression force is applied to the piezoelectric element, compressing the Belleville springs while the tube spring remains at its free (uncompressed) length. The compression force can be applied directly to the piezoelectric element with the piezoelectric element being surrounded by an injector body structure except for on open region where the compression force is being applied. In some embodiments, rather than there being an open region of the injector body where a compression force is directly applied to the piezoelectric element, there is a “moveable portion” of the injector body that moves, with the compression force and compresses the piezoelectric element. It is understood that this moveable portion of the injector body can be arranged to travel within the body, for example, utilizing a slit and grove sliding system, as well as bend, flex or otherwise alter its shape so as to move with the compression force and compress the piezoelectric element.

The Belleville springs can be sandwiched between the piezoelectric element and an endcap and/or a portion of a surrounding injector body such that as the compression force is applied to the piezoelectric element the piezoelectric element presses against the Belleville springs and the endcap, compressing the Belleville springs. Once the desired compression of the Belleville springs has been achieved, for example, providing a return force equivalent to the desired preload force, the package can be further sealed, for example, in embodiments with an open region as discussed above, by affixing an additional endcap portion onto the package completely enclosing it, thus maintaining the current level of compression. In embodiments with a moveable portion, as discussed above, the present level of compression can be maintained by affixing the moveable portion in a desired location, thus preventing further movement of the moveable portion. The various “affixing” steps mentioned herein can be performed utilizing any permanent or temporary method of affixing objects in place known in the art, for example, welding and utilizing various adhesives. The free length tube spring can then be secured in place.

In some embodiments, once a desired preload compression of the piezoelectric element and the corresponding Belleville springs has been obtained, the preload force is maintained by affixing the additional endcap portion, or affixing a moveable portion of the injector body structure (in those embodiments), to the tube spring itself. The resulting pushback force from the previously compressed Belleville springs pushes against the piezoelectric element and the endcap portion (or moveable portion), stretching and securing the tube spring in a desired preload position.

Throughout this disclosure, the preferred embodiments herein and examples illustrated are provided as exemplars, rather than as limitations on the scope of the present disclosure. As used herein, the terms “invention,” “method,” “present method” or “present invention” refers to any one of the embodiments incorporating features of the invention described herein, and any equivalents. Furthermore, reference to various feature(s) of the “invention,” “method,” “present method” or “present invention” throughout this document does not mean that all claimed embodiments or methods must include the referenced feature(s).

It is also understood that when an element or feature is referred to as being “on” or “adjacent” another element or feature, it can be directly on or adjacent the other element or feature or intervening elements or features that may also be present. Furthermore, relative terms such as “outer”, “above”, “lower”, “below”, and similar terms, may be used herein, to describe a relationship of one feature to another. It is understood that these terms are intended to encompass different orientations in addition, to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. For example, when the present specification refers to “a” transducer, it is understood that this language encompasses a single transducer or a plurality or array of transducers. It will be further understood that the terms “comprises,” “comprising,” “includes” and/or “including when used herein, specify the presence of stated features, integers, steps, operations, elements, and/or components, but do not preclude the presence or addition of one or more other features, integers, steps, operations, elements, components, and/or groups thereof.

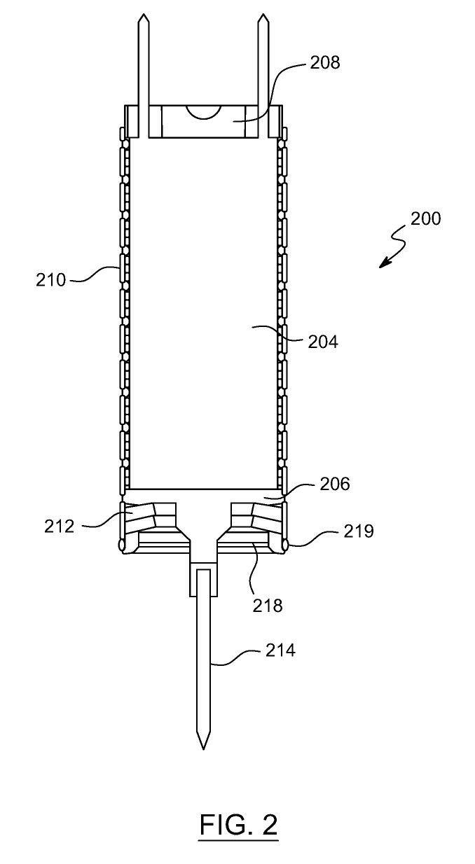

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. Embodiments utilizing such methods are discussed in more detail further below, for example, during the progression of FIGS. 2-4.

Embodiments according to the present disclosure can be utilized with various fuel injection systems, including injection systems utilizing fuels under heated and/or supercritical conditions, examples of which are set forth in the following patent documents, including their drawings, schematics, diagrams and related written description: U.S. Pat. No. 8,402,951 U.S. Pat. No. 8,176,900; U.S. Pat. No. 8,116,963; U.S. Pat. No. 8,079,348; U.S. Pat. No. 7,992,545; U.S. Pat. No. 7,966,990; U.S. Pat. No. 7,945,375; U.S. Pat. No. 7,762,236; U.S. Pat. No. 7,743,754; U.S. Pat. No. 7,657,363; U.S. Pat. No. 7,546,826; and U.S. Pat. No. 7,444,230. These documents are hereby incorporated herein in their entirety by reference.

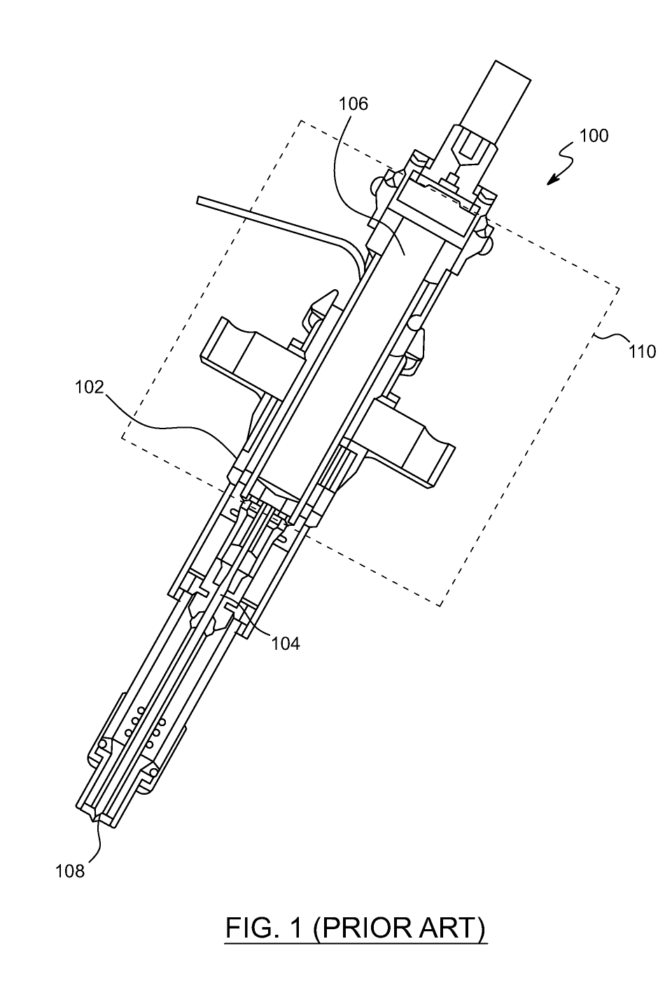

Before explaining methods and devices incorporating features of the present invention in greater detail, it would be useful to set forth an example environment in which such methods and devices can be Utilized. FIG. 1 shows an example of a fuel injector 100 comprising a fuel injector body 102 and a fuel injector pin 104 which is in communication with a piezoelectric element 106. When the piezoelectric element 106 is actuated, it expands causing fuel injector pin 104 to be pushed forward, and thus injects fuel into the engine through the fuel injector opening 108. Further details of such example fuel injector environments are set forth in U.S. Pat. No. 7,992,545 to Frick, et al., filed on Jun. 16, 2010 and issued on Aug. 3, 2011, which is hereby incorporated herein in its entirety by reference.

A portion of the fuel injector 100 of FIG. 1 in which preloaded piezoelectric packages according to the present invention can be utilized is defined by the dashed box 110, which encompasses a portion of the fuel injector body 102 and the piezoelectric element 106. An enlarged view of the portion of the fuel injector 100 of FIG. 1 defined by the dashed box 110, incorporating features of the present invention, is shown in FIG. 2.

FIG. 2 shows a piezoelectric fuel injector package 200, comprising a piezoelectric element 204, a first endcap 206, a second endcap 208, a tube spring 210, one or more Belleville springs 212 configured in series with the tube spring 210, a fuel injector pin 214, and a spring retainer 218, to which the tube spring 210 is connected to at a first connection point 219. The spring retainer 218 can be an integrated part of the first endcap 206 or can be a separate structure configured to retain the tube spring 210 in the desired position. The piezoelectric fuel injector package 200 can replace the corresponding section of the overall fuel injector, such as the section represented by dashed box 110 in FIG. 1 above or the piezoelectric fuel injector package 200 can be integrated into or housed within the corresponding section.

During assembly of the piezoelectric fuel injector package 200, the piezoelectric element 204 is arranged such that it is adjacent to and/or abuts against the first endcap 206. The first endcap 206 is typically configured with a fuel injector pin 214 such that as piezoelectric element 204 is actuated, the fuel injector pin is displaced. The fuel injector pin does not need to be connected to the first endcap 206 as shown, and can be configured in many different arrangements that allow the force and/or motion of the piezoelectric element 204 to transfer to the fuel injector pin 214. The first endcap 206 can be a separate structure connected to the fuel injector pin or can foe a top or cap portion of the fuel injector pin 214 itself.

The tube spring 210 can be a separate structure or can be an integrated portion of a surrounding injector body itself, for example, by forming the injector body such that it comprises the necessary slots, grooves and/or bellowed portions to create a spring structure. The Belleville springs 212 can comprise a Belleville washer or any suitable coned-disc spring. In the embodiment shown, the tube spring 210 is affixed to the spring retainer 218 at a first connection point 219. By having only a single end of the tube spring 210 affixed to the first endcap 206, the tube spring 210 can maintain its free (uncompressed/stretched) length during the majority of the assembly process.

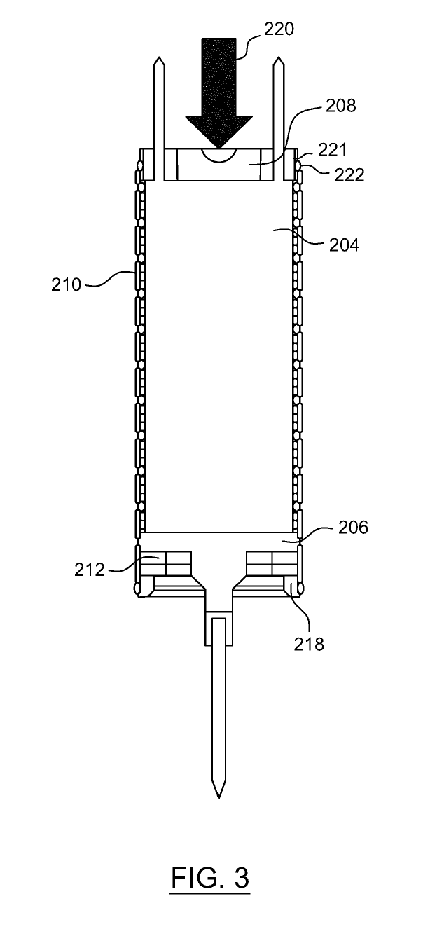

FIGS. 2-4 show a progressive preloading method incorporating features of the present invention. As shown in FIG. 2, the Belleville springs 212 are not yet compressed. As shown in FIG. 3, wherein like structures are denoted by like reference features, during assembly of the piezoelectric fuel injector package 200 a force 220 is applied to the endcap 208. This force can be transmitted through intervening elements, for example a moveable second endcap 203 portion as described above.

The applied force 220 compresses the piezoelectric element 204, pushing the piezoelectric element 204 against the first endcap 206 and thus compressing the Belleville springs 212 into a flat position (as shown) reducing the space between the first endcap 206 and the spring retainer 218. The tube spring 210, which is arranged in series with the Belleville spring 212, maintains its free length during the preload process. As mentioned above, tube springs tend to have a high spring rate and require a precise assembly process. By allowing the tube spring to maintain its free length and not undergo significant stress during the preload setting process, damage to the tube spring can be mitigated and the overall process simplified.

While two Belleville springs 212 are shown, single or various multiple stacked Belleville springs 212 can also be utilized. The tube spring 210 and the Belleville spring 212 can also be arranged in a variety of different ways in series or in parallel, for example, one or more Belleville springs can be arranged near a top surface 221 of the package 200 and thus be arranged on one or more, tube spring 210.

After the Belleville springs have been sufficiently compressed, for example, through application of a desired force value, the preload value can be maintained. To maintain the package force value, the second endcap 208 can be secured in position, and thus maintain the preload force value on the piezoelectric element 204. The adjacent end of the tube spring 210 is affixed to the second endcap 208 at a second connection point 222. The second endcap 208 can be made immobile or less moveable as desired by securing the second endcap 208 to the piezoelectric element 204, and/or the tube spring 210 by various attachment methods know in the art, for example, soldering and welding.

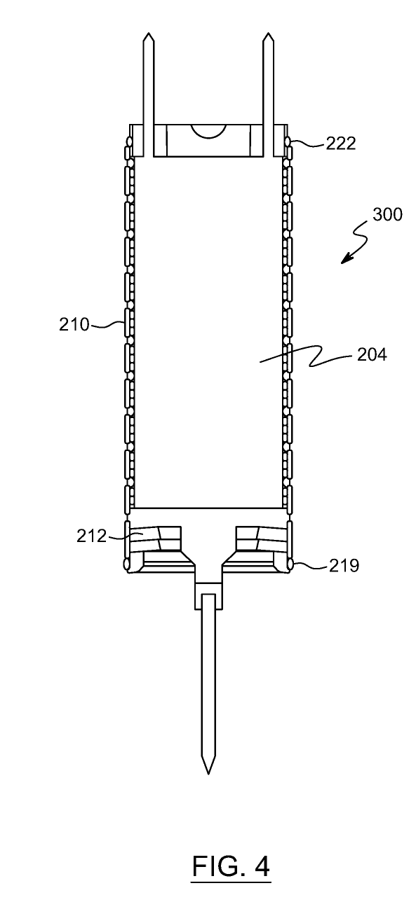

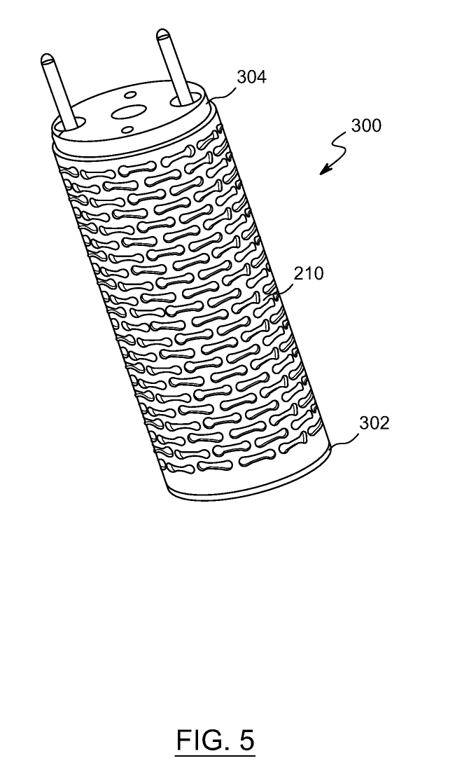

FIG. 4 shows a preloaded version of fuel injector package 300. As shown in FIG. 4, the Belleville springs 212 have returned, to slightly decompressed position, pushing upward on the piezoelectric element 204 and stretching and securing the tube spring 210 in a desired preload position. The tube spring is shown affixed to the endcaps at the first and second connection points 219, 222. FIG. 5 shows a perspective view of the preloaded fuel injector package 300 in FIG. 4 with the tube spring 210 affixed to the first and second endcaps 302, 304.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention, wherein no portion of the disclosure is intended, expressly or implicitly, to be dedicated to the public domain if not set forth in the claims.

1. A piezoelectric fuel injector spring assembly, comprising:
at least one piezoelectric element (204);
at least one first spring (212); and
at least one second spring (210);
wherein the at least one first spring (212) biases the at least one second spring (210) by expanding the at least one second spring (210); and
the at least one second spring (210) is further expanded when the piezoelectric element (204) expands.

2. The piezoelectric fuel injector spring assembly according to claim 1, wherein a first end of the at least one piezoelectric element (204) is connected in a force transmitting fashion directly or indirectly to a first end of the at least one second spring (210) and a second end of the at least one piezoelectric element (204) is connected in a force transmitting fashion directly or indirectly to a second end of the at least one second spring (210).

3. The piezoelectric fuel injector spring assembly according to claim 2, wherein a first end of the at least one piezoelectric element (204) is connected indirectly in a force transmitting fashion by a first endcap (206) to the first end of the at least one second spring (210) and the second end of the at least one piezoelectric element (204) is connected indirectly by a second endcap (208) in a force transmitting fashion to the second end of the at least one second spring (210).

4. The piezoelectric fuel injector spring assembly according to claim 1, wherein the at least one second spring (210) is a different kind of spring compared to the at least one first spring (212).

5. The piezoelectric fuel injector spring assembly according to claim 1, wherein the at least one second spring (210) is a tube spring and the at least one piezoelectric element (204) is contained within the tube spring.

6. The piezoelectric fuel injector spring assembly according to claim 1, wherein the at least one first spring (212) is a Belleville spring.

7. The piezoelectric fuel injector spring assembly according to claim 3, wherein the at least one first spring (212) is a Belleville spring that is sandwiched between the first endcap (206) and a movable element, the movable element being connected in a force transmitting fashion with the first end of the at least one piezoelectric element (204).

8. The piezoelectric fuel injector spring assembly according to claim 7, wherein upon expansion of the at least one piezoelectric element (204) the movable element compresses the at least one first spring (212) such that force is transmitted via the at least one first spring (212) and the first endcap (206) into the first end of the at least one second spring (210), said transmitted force expanding the at least one second spring (210).

9. The piezoelectric fuel injector spring assembly according to claim 8, wherein the at least one first spring (212) is compressed to the point of reaching its entirely flat configuration upon the expansion of the at least one piezoelectric element (204).

10. The piezoelectric fuel injector spring assembly according to claim 1, wherein the first end of the piezoelectric element (204) is connected directly or indirectly to a fuel injector pin (214) such that it moves the fuel injector pin (214) when the piezoelectric element (204) expands.

11. An assembly method for assembling a piezoelectric fuel injector spring assembly that comprises at least one piezoelectric element (204) having a first and a second end, at least one first spring (212), and at least one second spring (210) having a first and a second end, the assembly method comprising the steps of:
connecting in a force transmitting fashion the first end of the piezoelectric element (204) via the at least one first spring (212) to the first end of the at least one second spring (210);
compressing the at least one first spring (212) by applying an external compressing force to the at least one first spring (212);
connecting in a force transmitting fashion the second end of the piezoelectric element (204) directly or indirectly to the second end of the at least one second spring (210); and
entirely releasing the external compressing force acting on the at least one first spring (212) so that the first spring (212) is partially released while expanding the at least one second spring (218) to the point where the spring forces of the at least one first spring (212) and the at least one second spring (210) reach an equilibrium.

12. The assembly method according to claim 11, comprising applying the compressing force to the at least one first spring (212) by pushing the second end of the piezoelectric element (204) against the at least one first spring (212) prior to connecting in a force transmitting fashion the second end of the piezoelectric element (204) to the second end of the at least one second spring (210).
